(19) United States
(12) Patent Application Publication
(10) Pub. No.: US 2024/0061000 A1
(43) Pub. Date: Feb. 22, 2024

(54) AUTOMATIC ANALYZING APPARATUS AND AUTOMATIC ANALYZING METHOD

(71) Applicant: Canon Medical Systems Corporation, Otawara-shi (JP)

(72) Inventors: Atsushi HOSOOKA, Otawara (JP); Mitsuo OKAMOTO, Nasushiobara (JP); Naoto SATO, Nasushiobara (JP); Masaaki SAITOU, Nasushiobara (JP); Reiko MARUYAMA, Nasushiobara (JP); Yuki MATSUMOTO, Sakura (JP); Kensuke OKUGI, Otawara (JP)

(73) Assignee: Canon Medical Systems Corporation, Otawara-shi (JP)

(21) Appl. No.: 18/450,584

(22) Filed: Aug. 16, 2023

(30) Foreign Application Priority Data
Aug. 18, 2022 (JP) 2022-130654

(51) Int. Cl. G01N 35/00; G01N 35/10

(52) U.S. Cl. CPC G01N 35/00663; G01N 35/1009; G01N 2035/00396; G01N 2035/1025

(57) ABSTRACT

According to one embodiment, an automatic analyzing apparatus includes processing circuitry. The processing circuitry measures an electrical potential pertaining to a contact between a probe for dispensing a sample or a reagent and a liquid surface, and outputs the measured electrical potential as a measurement value, determines whether or not the measurement value is within a specific range, and outputs a determination result, and provides a notification on a state of a liquid related to the liquid surface according to the determination result.

### CROSS-REFERENCE TO RELATED APPLICATION(S)

This application is based upon and claims the benefit of priority from Japanese Patent Application No. 2022-130654, filed Aug. 18, 2022, the entire contents of which are incorporated herein by reference.

### FIELD

Embodiments described herein relate generally to an automatic analyzing apparatus and an automatic analyzing method.

### BACKGROUND

Generally, a washing mechanism employed for an automatic analyzing apparatus automatically dilutes a detergent and uses it as a washing liquid. Techniques for securing a given washing performance of such a washing mechanism, e.g., detecting clogging in a washing liquid discharging nozzle and detecting an amount of a discharged washing liquid, are known. However, whether or not the automatic detergent diluting mechanism is operating normally, that is, whether or not a proper washing liquid is being provided via diluting, needs to be checked by a serviceman using a pH measurement instrument, etc., and a simplified means of checking is yet to be known.

By the way, an automatic analyzing apparatus is equipped with a constant temperature bath for storing constant temperature water for keeping reaction containers at a given temperature, and this constant temperature water contains an additive for preventing the growth of germs, etc. The additive in constant temperature water should be present in a proper amount. Here, the amount of the additive contained in constant temperature water also needs to be checked by a serviceman using a pH measurement instrument, etc., and a simplified means of checking this also remains unknown.

### BRIEF DESCRIPTION OF THE DRAWINGS

FIG. 1 is a block diagram showing an exemplary functional configuration of an automatic analyzing apparatus according to a first embodiment.

FIG. 2 is a perspective view showing an exemplary component configuration of the analysis mechanism shown in FIG. 1.

FIG. 3 is a flowchart showing exemplary processing steps in a washing liquid state checking process performed by the automatic analyzing apparatus according to the first embodiment.

FIG. 4 is a graph showing an exemplary form of an electrical potential which appears in liquid level detection for a washing liquid in the first embodiment.

FIG. 5 is a flowchart showing exemplary processing steps in the abnormal state notification process included in the flowchart in FIG. 3.

FIG. 6 is a top view of a protrusion of the constant temperature bath shown in FIG. 2.

FIG. 7 is a sectional view taken along the line X-X indicated in FIG. 6.

FIG. 8 is a flowchart showing exemplary processing steps in a constant temperature water state checking process performed by an automatic analyzing apparatus according to a second embodiment.

FIG. 9 is a graph showing an exemplary form of an electrical potential which appears in liquid level detection for a constant temperature water in the second embodiment.

FIG. 10 is a flowchart showing exemplary processing steps in the additive concentration adjusting process included in the flowchart in FIG. 8.

### DETAILED DESCRIPTION

In general, according to one embodiment, an automatic analyzing apparatus includes processing circuitry. The processing circuitry measures an electrical potential pertaining to a contact between a probe for dispensing a sample or a reagent and a liquid surface, and outputs the measured electrical potential as a measurement value, determines whether or not the measurement value is within a specific range, and outputs a determination result, and provides a notification on a state of a liquid related to the liquid surface according to the determination result.

The embodiments will be described in more detail with reference to the drawings.

### First Embodiment

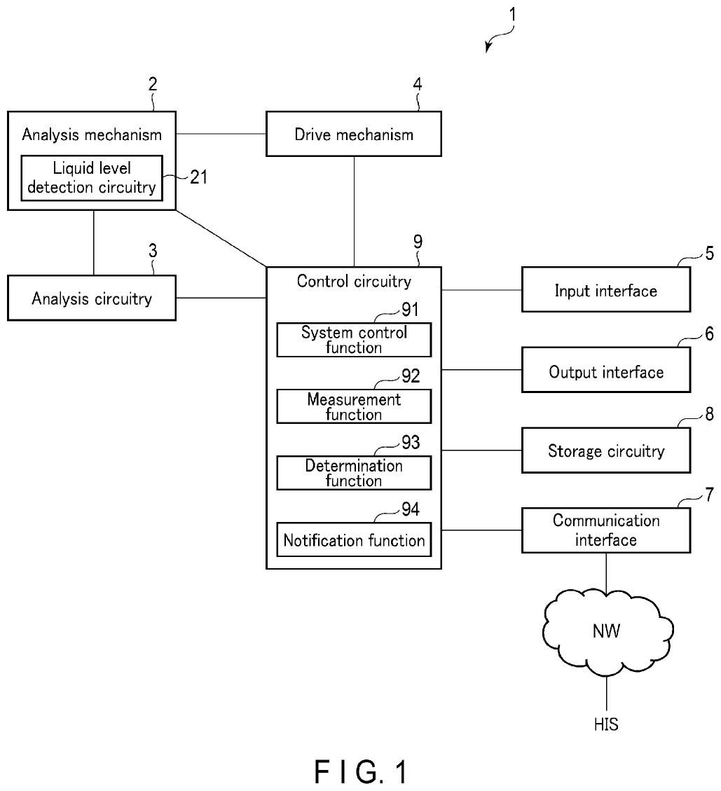

FIG. 1 is a block diagram showing an exemplary functional configuration of an automatic analyzing apparatus 1 according to the first embodiment. As shown in FIG. 1, the automatic analyzing apparatus 1 includes an analysis mechanism 2, analysis circuitry 3, a drive mechanism 4, an input interface 5, an output interface 6, a communication interface 7, storage circuitry 8, and control circuitry 9. The communication interface 7 is connected to a hospital information system (HIS) via an in-hospital network NW.

The analysis mechanism 2 mixes a sample, such as a standard sample (which may be called a “calibrator”) or a subject sample (which may be called an “analyte”), with a reagent for the test item set for the sample. The analysis mechanism 2 measures the mixture liquid of the sample and the reagent to generate standard data and subject data which may be represented as, for example, an absorbency level. The analysis mechanism 2 includes liquid level detection circuitry (liquid level detector) 21. A more detailed description of the analysis mechanism 2 and the liquid level detection circuitry 21 will be given later.

The analysis circuitry 3 is a processor to analyze the standard data and the subject data, generated by the analysis mechanism 2, to generate data such as calibration data and analysis data. In one example, the analysis circuitry 3 reads an analysis program from the storage circuitry 8 and analyzes the standard data and the subject data according to the read analysis program. The analysis circuitry 3 may be provided with a storage area for storing at least a part of the data stored in the storage circuitry 8.

The drive mechanism 4 drives the analysis mechanism 2 under the control of the control circuitry 9. The drive mechanism 4 is realized by, for example, a combination of a gear, a stepping motor, a belt conveyor, a lead screw, and so on.

The input interface 5, in one example, accepts settings for analysis parameters, etc., associated with each test item intended for a measurement target sample specified by an operator or requested via the in-hospital network NW. The input interface 5 is realized by, for example, one or more of a mouse, a keyboard, a touch pad or a touch panel on which instructions are input by touching an operation screen, and the like. The input interface 5 is connected to the control circuitry 9 so that it converts operational commands input by an operator into electric signals and outputs them to the control circuitry 9. The input interface 5 is one example of an inputter.

In the disclosure herein, the input interface 5 is not limited to physical operating components such as a mouse and a keyboard. Examples of the input interface 5 also include processing circuitry for electric signals which is adapted to receive an electric signal corresponding to an operational command input from an external input device separate from the automatic analyzing apparatus 1 and to output this electric signal to the control circuitry 9.

The output interface 6 is an interface connected to the control circuitry 9 and outputs signals coming from the control circuitry 9. The output interface 6 is realized by, for example, one or more of display circuitry, print circuitry, an audio device, and the like. The output interface 6 is one example of an outputter.

Examples of the display circuitry here include display devices such as a CRT display, a liquid crystal display, an organic EL display, an LED display, and a plasma display. Also, the display circuitry may include processing circuitry for converting data of a display subject into video signals and supplying the video signals to external entities. Examples of the print circuitry include a printer, etc. The print circuitry may also include output circuitry for supplying data of a print subject to external entities. Examples of the audio device include a speaker, etc. The audio device may also include output circuitry for supplying audio signals to external entities. Note that the output interface 6 and the input interface 5 may be realized together in the form of a touch panel, a touch screen, or the like.

The communication interface 7, in one example, is connected to the in-hospital network NW. The communication interface 7 performs data communication with the HIS via the in-hospital network NW. It is also possible for the communication interface 7 to perform data communication with the HIS via a laboratory information system (LIS) connected to the in-hospital network NW.

The storage circuitry 8 stores one or more analysis programs for the analysis circuitry 3 to execute, and one or more control programs for the control circuitry 9 to realize its functions. The storage circuitry 8 stores, for each test item, calibration data generated by the analysis circuitry 3. The storage circuitry 8 also stores, for each sample, analysis data generated by the analysis circuitry 3. The storage circuitry 8 stores a test order input from an operator, etc., or a test order received by the communication interface 7 via the in-hospital network NW, etc.

The storage circuitry 8 is a memory device for storing various information sets and its examples include a hard disk drive (HDD), a solid state drive (SSD), an integrated circuit, and so on. In addition to, or instead of, an HDD, an SSD, etc., the storage circuitry 8 may be any portable storage medium such as a compact disc (CD), a digital versatile disc (DVD), and a flash memory. Note also that the storage circuitry 8 may also be a drive device adapted to read and write various information sets from and to devices such as a semiconductor memory device represented by a flash memory, a RAM, etc. The storage circuitry 8 may be called a “memory”.

The storage circuitry 8 also stores a program or programs to be executed by the control circuitry 9, various data sets for use in the processes performed by the control circuitry 9, and so on. Such programs may be, for example, installed on a computer from a given network or non-transitory computer-readable storage medium in advance so that the computer will realize each function of the control circuitry 9. In the disclosure herein, various data sets typically include digital data. The storage circuitry 8 is one example of a storage.

The control circuitry 9 is, for example, one or more processors functioning as a center of the automatic analyzing apparatus 1. The control circuitry 9 executes the program stored in the storage circuitry 8 to realize a function corresponding to the executed program. Functions realized by the control circuitry 9 will be described in more detail later. The control circuitry 9 may be provided with a storage area for storing at least a part of the data stored in the storage circuitry 8. The control circuitry 9 may be called a “controller” or a “processing circuitry”.

An exemplary functional configuration of the automatic analyzing apparatus 1 according to the first embodiment has been described. Next, a configuration of the analysis mechanism 2 will be described in detail.

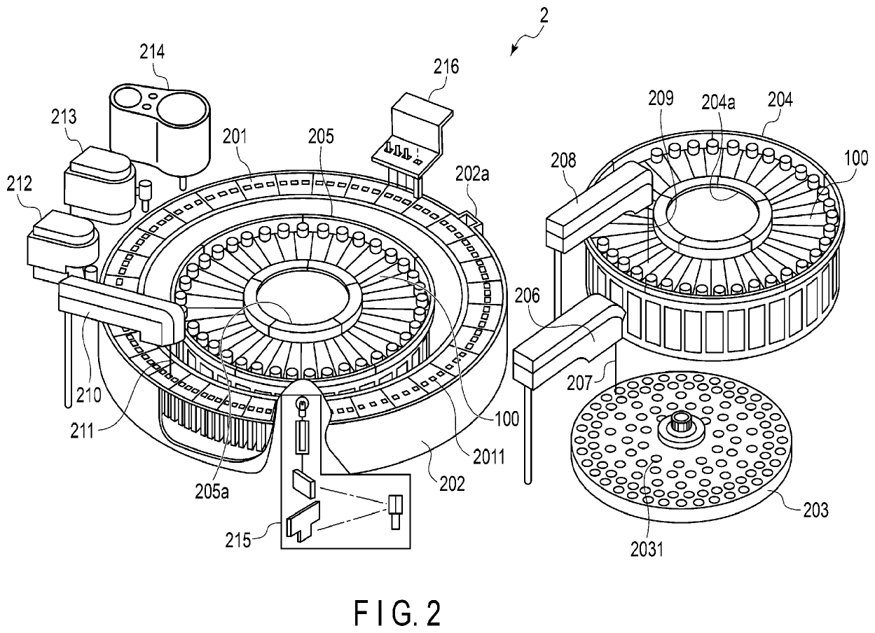

FIG. 2 is a perspective view showing an exemplary component configuration of the analysis mechanism shown in FIG. 1. In FIG. 2, the analysis mechanism 2 includes a reaction disk 201, a constant temperature bath 202, a sample disk 203, a first reagent depository 204, and a second reagent depository 205. The analysis mechanism 2 also includes a sample dispensing arm 206, a sample dispensing probe 207, a first reagent dispensing arm 208, a first reagent dispensing probe 209, a second reagent dispensing arm 210, and a second reagent dispensing probe 211. The analysis mechanism 2 further includes a first stirring unit 212, a second stirring unit 213, an electrode unit 214, a photometry unit 215, and a washing unit 216.

First, a description will be given of the reaction disk 201, the constant temperature bath 202, the sample disk 203, the first reagent depository 204, and the second reagent depository 205.

The reaction disk 201 holds multiple reaction containers 2011 in an annular arrangement. The reaction disk 201 conveys these reaction containers 2011 along a predetermined path. As one concrete configuration, the reaction disk 201 is turned and stopped in an alternating manner during a test procedure, and this alternating motion may be repeated at regular time intervals (hereinafter, each time interval will be called “one cycle”). Each reaction container 2011 may be formed of, for example, a glass material, a polypropylene (PP) material, or an acrylic material. Each reaction container 2011 may be called a “reaction tube” or a “cell”. Also, the motion of the reaction disk 201 during a test procedure may be called a “cycle motion”.

The constant temperature bath 202 stores, for example, water (constant temperature water) kept at a predetermined temperature (normally, 37° C.). In one example, such constant temperature water contains an additive for anti-bacterial purposes. In the constant temperature bath 202, the reaction containers 2011 are immersed in the stored constant temperature water so that the temperature of a liquid (a mixture liquid) contained in each reaction container 2011 is warmed and kept constant. Note that there is a protrusion 202a formed at the outer circumference of the constant temperature bath 202 and this protrusion 202a permits direct access to the constant temperature water through the use of a dispensing probe, etc.

The sample disk 203 is provided near the reaction disk 201. The sample disk 203 holds, in an annular arrangement, multiple sample containers 2031 each containing a sample such as blood. The sample disk 203 is rotated to move the sample container 2031 that contains a dispensing target sample to a sample aspirating position.

The first reagent depository 204 is adapted for cold storage of multiple reagent containers 100 containing a first reagent for reaction with a given component in standard samples and subject samples. While not illustrated in FIG. 2, the first reagent depository 204 may be covered by a detachable reagent cover. The first reagent depository 204 encloses reagent racks 204a in such a manner that the reagent racks 204a can turn. These reagent racks 204a also hold the multiple reagent containers 100 in an annular arrangement. The reagent racks 204a are turned by the drive mechanism 4.

The second reagent depository 205 is adapted for cold storage of, for example, reagent containers 100 that contain a second reagent constituting a dual-reagent system with the first reagent. While not illustrated in FIG. 2, the second reagent depository 205 may be covered by a detachable reagent cover. The second reagent depository 205 encloses reagent racks 205a in such a manner that the reagent racks 205a can turn. These reagent racks 205a also hold the multiple reagent containers 100 in an annular arrangement. The reagent racks 205a are turned by the drive mechanism 4. Note that the second reagent kept at low temperature in the second reagent depository 205 may be a reagent of the same components and the same concentration as the first reagent kept at low temperature in the first reagent depository 204.

Next, the sample dispensing arm 206, the sample dispensing probe 207, the first reagent dispensing arm 208, the first reagent dispensing probe 209, the second reagent dispensing arm 210, and the second reagent dispensing probe 211 will be described.

In one example, the sample dispensing arm 206 is provided between the reaction disk 201 and the sample disk 203. The sample dispensing arm 206 is driven by the drive mechanism 4 so that it can vertically ascend and descend and also horizontally rotate. The sample dispensing arm 206 carries the sample dispensing probe 207 at its one end.

In one example, the sample dispensing probe 207 is driven by the drive mechanism 4 so that it aspirates a sample from the sample container 2031 held by the sample disk 203. Also, the sample dispensing probe 207 in one example is driven by the drive mechanism 4 so that it discharges the aspirated sample to the reaction container 2011 held by the reaction disk 201. Here, the position where the reaction container 2011 is placed for receiving the discharged sample may be called a “sample discharging position”. The sample discharging position is set on the circling trajectory of the sample dispensing probe 207.

In one example, the first reagent dispensing arm 208 is provided between the reaction disk 201 and the first reagent depository 204. The first reagent dispensing arm 208 is driven by the drive mechanism 4 so that it can vertically ascend and descend and also horizontally rotate. The first reagent dispensing arm 208 carries the first reagent dispensing probe 209 at its one end.

In one example, the first reagent dispensing probe 209 is driven by the drive mechanism 4 so that it aspirates the first reagent from the reagent container 100 held by the first reagent depository 204. Also, the first reagent dispensing probe 209 in one example is driven by the drive mechanism 4 so that it discharges the aspirated first reagent to the reaction container 2011 held by the reaction disk 201. Here, the position where the reaction container 2011 is placed for receiving the discharged first reagent may be called a “first reagent discharging position”. The first reagent discharging position is set on the circling trajectory of the first reagent dispensing probe 209.

In one example, the second reagent dispensing arm 210 is provided near the outer periphery of the reaction disk 201. The second reagent dispensing arm 210 is driven by the drive mechanism 4 so that it can vertically ascend and descend and also horizontally rotate. The second reagent dispensing arm 210 carries the second reagent dispensing probe 211 at its one end.

In one example, the second reagent dispensing probe 211 is driven by the drive mechanism 4 so that it aspirates the second reagent from the reagent container 100 held by the second reagent depository 205. Also, the second reagent dispensing probe 211 in one example is driven by the drive mechanism 4 so that it discharges the aspirated second reagent to the reaction container 2011 held by the reaction disk 201. Here, the position where the reaction container 2011 is placed for receiving the discharged second reagent may be called a “second reagent discharging position”. The second reagent discharging position is set on the circling trajectory of the second reagent dispensing probe 211.

Next, the first stirring unit 212, the second stirring unit 213, the electrode unit 214, the photometry unit 215, and the washing unit 216 will be described.

In one example, the first stirring unit 212 is provided near the outer periphery of the reaction disk 201. The first stirring unit 212 includes a first stirring arm and a first stirring tool. The first stirring arm is driven by the drive mechanism 4 so that it can vertically ascend and descend and also horizontally rotate. The first stirring tool is provided at one end of the first stirring arm. In one example, the first stirring tool is driven by the drive mechanism 4 so that it stirs the mixture liquid of the sample and the first reagent contained in the reaction container 2011 on the reaction disk 201.

In one example, the second stirring unit 213 is provided near the outer periphery of the reaction disk 201. The second stirring unit 213 includes a second stirring arm and a second stirring tool. The second stirring arm is driven by the drive mechanism 4 so that it can vertically ascend and descend and also horizontally rotate. The second stirring tool is provided at one end of the second stirring arm. In one example, the second stirring tool is driven by the drive mechanism 4 so that it stirs the mixture liquid of the sample, the first reagent, and the second reagent contained in the reaction container 2011 on the reaction disk 201.

In one example, the electrode unit 214 is provided near the outer periphery of the reaction disk 201. The electrode unit 214 measures the electrolyte concentration of the mixture liquid discharged into the reaction container 2011. The electrode unit 214 includes an ion selective electrode (ISE) and a reference electrode. Under the control of the control circuitry 9, the electrode unit 214 measures the electrical potential between the ISE and the reference electrode for the mixture liquid containing measurement target ions. The electrode unit 214 outputs data on the measured electrical potential, which serves as either the standard data or the subject data, to the analysis circuitry 3.

The photometry unit 215 may be provided at, for example, a desired position between the inner circumference and the outer circumference of the reaction disk 201. The photometry unit 215 optically measures given components in the mixture liquid discharged into the reaction container 2011. The photometry unit 215 includes a light source and a photodetector. In one example, the light source is provided on the inner circumference side of the reaction disk 201, and the photodetector is provided on the outer circumference side of the reaction disk 201. The light source emits light under the control of the control circuitry 9. The emitted light enters the reaction container 2011 through a first sidewall and exits the reaction container 2011 through a second sidewall opposite the first sidewall. The photodetector detects the light coming out of the reaction container 2011.

More specifically, the photodetector in one example detects light that has passed through the mixture liquid of a standard sample and a reagent in the reaction container 2011, and generates standard data represented as an absorbency level, etc., based on the intensity of the detected light. In one example, the photodetector also detects light that has passed through the mixture liquid of a subject sample and a reagent in the reaction container 2011, and generates subject data represented as an absorbency level, etc., based on the intensity of the detected light. The photometry unit 215 outputs the generated standard data and subject data to the analysis circuitry 3.

The washing unit 216 is provided near the outer periphery of the reaction disk 201. The washing unit 216 washes the inside of each reaction container 2011 for which the measurement of the mixture liquid by the electrode unit 214 or the photometry unit 215 has been finished. In one example, the washing unit 216 includes a detergent bottle (not illustrated) adapted to retain a detergent for washing the reaction containers 2011, a washing liquid preparing mechanism for preparing a washing liquid of a given concentration by adjusting a supplied amount of the detergent using an electromagnetic valve, etc., and a washing liquid supply pump (not illustrated) for supplying the prepared washing liquid. The washing unit 216 also includes a washing nozzle (not illustrated) for discharging the washing liquid supplied by the washing liquid supply pump into the reaction container 2011 and for suctioning the mixture liquid and the washing liquid remaining in the reaction container 2011.

The washing liquid supplied from the washing unit 216 is prepared by, for example, diluting a high-concentration detergent to a predetermined concentration. Examples of the available types of the detergent include an acid detergent and an alkaline detergent. For the embodiment, the description will simply mention “a detergent” or “the detergent” if it is not required to distinguish between the acid type, alkaline type, and the like of the detergent.

Exemplary configurations of the automatic analyzing apparatus 1 and the analysis mechanism 2 according to the first embodiment have been described. Next, a configuration of the liquid level detection circuitry 21 in the automatic analyzing apparatus 1 according to the first embodiment will be described in detail.

In one example, the liquid level detection circuitry 21 includes an oscillation circuit, a bridge circuit, a differential-amplification circuit, a synchronous detector circuit, an integration circuit, an amplifier circuit, a comparator circuit, and an automatic phase-shift circuit. The liquid level detection circuitry 21 is connected to a desired dispensing probe to realize the function of detecting a contact between the probe and a liquid (the surface of a liquid), namely, a liquid level detecting function. Such a desired dispensing probe may be a sample dispensing probe, a reagent dispensing probe, etc. The description will assume an instance where the liquid level detection circuitry 21 detects a contact between the sample dispensing probe 207 and a liquid surface. Note that the description will be likewise applicable to instances of using the first reagent dispensing probe 209 and the second reagent dispensing probe 211. Also, since the liquid level detection is performed through the probe, the dispensing probe employed here may be understood as a probe having the liquid level detecting function.

The liquid level detection circuitry 21 is electrically connected to the sample dispensing probe 207. The liquid level detection circuitry 21 detects a contact between the sample dispensing probe 207 and a liquid surface, and outputs information based on this detection (“detection information”) to the control circuitry 9. The detection information includes, for example, information obtained at the moment of contacting the liquid surface, and information obtained during contact with the liquid surface.

The oscillation circuit generates an oscillation signal of a predetermined frequency. The oscillation circuit outputs the oscillation signal to the bridge circuit and the automatic phase-shift circuit.

The bridge circuit receives an input of the oscillation signal from the oscillation circuit. The bridge circuit is electrically connected to the sample dispensing probe 207. The bridge circuit outputs a potential difference (a voltage) between two connection points in the circuit to the differential-amplification circuit.

The differential-amplification circuit receives, from the bridge circuit, an input of a voltage signal with the potential difference. The differential-amplification circuit generates a differentially amplified signal by subjecting the input voltage signal to differential amplification, and outputs the differentially amplified signal to the synchronous detector circuit.

The synchronous detector circuit receives an input of the differentially amplified signal from the differential-amplification circuit and an input of a reference signal from the automatic phase-shift circuit. The synchronous detector circuit operates as if it selectively picks out only the differentially amplified signal with the same frequency component as that of the reference signal. More specifically, the synchronous detector circuit generates a synchronized detection signal by performing a full-wave rectification based on polarities of the differentially amplified signal and the synchronized reference signal, and outputs the synchronized detection signal to the integrating circuit.

In the case where the sample dispensing probe 207 and a liquid surface are not in contact with each other, the synchronized detection signal output from the synchronous detector circuit is indicative of zero, as the phase difference between the differentially amplified signal and the reference signal is set to be 90 degrees. Even if the differentially amplified signal is varied to some extent, the synchronized detection signal output from the synchronous detector circuit indicates zero, since the phase of the reference signal is adjusted by the automatic phase-shift circuit.

The integration circuit receives an input of the synchronized detection signal from the synchronous detector circuit. The integration circuit generates a low-pass signal by blocking a frequency component of the synchronized detection signal that is equal to or higher than a predetermined frequency while permitting the other frequency components to pass through, and outputs this low-pass signal to the amplifier circuit.

The amplifier circuit receives an input of the low-pass signal from the integration circuit. The amplifier circuit generates its output signal by amplifying the low-pass signal, and outputs this output signal to the comparator circuit and the automatic phase-shift circuit.

The comparator circuit receives an input of the output signal from the amplifier circuit. The comparator circuit accordingly generates the aforementioned detection information by comparing the output signal with preset detection levels. For example, the detection information constituted by the information at the moment of contacting a liquid surface is obtained by inputting the output signal to a differentiation circuit and then inputting an output from this differentiation circuit to the comparator. Also, for example, the detection information constituted by the information during the contact with a liquid surface is obtained by inputting the output signal to the comparator. The comparator circuit outputs the detection information to the control circuitry 9.

The automatic phase-shift circuit receives an input of the oscillation signal from the oscillation circuit, an input of the output signal from the amplifier circuit, and an input of a zero adjustment signal from the control circuitry 9. In response to the input of the zero adjustment signal as a trigger, the automatic phase-shift circuit generates the reference signal based on the oscillation signal and the output signal. The reference signal here has a phase difference of 90 degrees from the oscillation signal. The automatic phase-shift circuit outputs the reference signal to the synchronous detector circuit.

Note that the detection information may include a voltage value (an electrical potential) pertaining to a contact between the sample dispensing probe 207 and a liquid surface. Such an electrical potential turns to substantially zero if the sample dispensing probe 207 and the liquid surface are not in contact with each other, and turns to a value according to components of the liquid if the sample dispensing probe 207 and the liquid surface are in contact with each other.

In summary, the liquid level detection circuitry 21 is capable of being electrically connected to a desired dispensing probe and outputting an electrical potential pertaining to a contact between the dispensing probe and a liquid surface.

An exemplary configuration of the liquid level detection circuitry 21 in the automatic analyzing apparatus 1 according to the first embodiment has been described. Next, a configuration of the control circuitry 9 in the automatic analyzing apparatus 1 according to the first embodiment will be described in detail.

The control circuitry 9 runs the program or programs read from the storage circuitry 8 to realize a system control function 91, a measurement function 92, a determination function 93, and a notification function 94. In other words, the control circuitry 9 has the system control function 91, the measurement function 92, the determination function 93, and the notification function 94. Note that the description of the present embodiment will assume that each function is realized by a single processor, but this does not intend a limitation. For example, multiple independent processors may be combined to form the control circuitry and each function may be realized by having the respective processors run the programs. Also, the system control function 91, the measurement function 92, the determination function 93, and the notification function 94 may be called a system control circuit, a measurement circuit, a determination circuit, and a notification circuit, respectively, and they may be implemented as individual hardware circuits. These explanations of the functions of the control circuitry 9 will also apply to the subsequent embodiments as well.

The term “processor” used by the disclosure herein refers to, for example, a central processing unit (CPU) or a graphics processing unit (GPU), or any of the various types of circuitry members including an application specific integrated circuit (ASIC), a programmable logic device such as a simple programmable logic device (SPLD), a complex programmable logic device (CPLD), or a field programmable gate array (FPGA), and so on. The processor reads the program or programs stored in the storage circuitry 8 and executes them to realize the corresponding functions.

Note that the programs may be incorporated directly within circuitry of the processor, instead of being stored in the storage circuitry 8. In this case, the processor reads the programs incorporated in its circuitry and executes them to realize the functions. The embodiments herein do not limit each processor to a single circuit-type processor. Multiple independent circuits may be combined and integrated as one processor to realize the intended functions. Furthermore, multiple components or features as given in FIG. 1 may be integrated into one processor to realize the respective functions. These explanations of the “processor” will also apply to the subsequent embodiments and their modifications as well.

The control circuitry 9 with the system control function 91 takes total control over the components of the automatic analyzing apparatus 1 according to input information input via the input interface 5. In one example, the control circuitry 9 with the system control function 91 controls the drive mechanism 4 so that measurement operations are conducted according to test items, and controls the analysis circuitry 3 to analyze the standard data and the subject data generated by the analysis mechanism 2. More specifically, the control circuitry 9 controls the rotation of the reaction disk 201, the pivoting and dispensing action of the sample dispensing probe 207, the pivoting and dispensing action of the first reagent dispensing probe 209, and the pivoting and dispensing action of the second reagent dispensing probe 211. The control circuitry 9 also controls the operations of the first stirring unit 212, the second stirring unit 213, the electrode unit 214, the photometry unit 215, and the washing unit 216. The control circuitry 9 that realizes the system control function 91 is one example of a system controller.

The measurement function 92 is a function of measuring an electrical potential pertaining to a contact between the probe for dispensing a sample or a reagent and a liquid surface. More specifically, the control circuitry 9 with the measurement function 92 measures an electrical potential pertaining to a contact between, for example, the sample dispensing probe 207 and a washing liquid discharged into the reaction container 2011, and outputs the measured electrical potential as a measurement value. The control circuitry 9 that realizes the measurement function 92 is one example of a measurer.

The determination function 93 is a function of determining whether or not the measurement value output by the measurement function 92 falls within a specific range. More specifically, the control circuitry 9 with the determination function 93 compares the measurement value with each given threshold to make various determinations and outputs a determination result. The control circuitry 9 that realizes the determination function 93 is one example of a determiner.

The notification function 94 is a function of notifying a user of the state of a liquid related to the liquid surface according to the determination result. More specifically, the control circuitry 9 with the notification function 94 performs user notification by, for example, controlling a display to present information on the state of the liquid related to the liquid surface according to the determination result. Examples of the state of a liquid here include a normal state and an abnormal state. Particulars of the normal state and the abnormal state will be described later. The control circuitry 9 that realizes the notification function 94 is one example of a notifier.

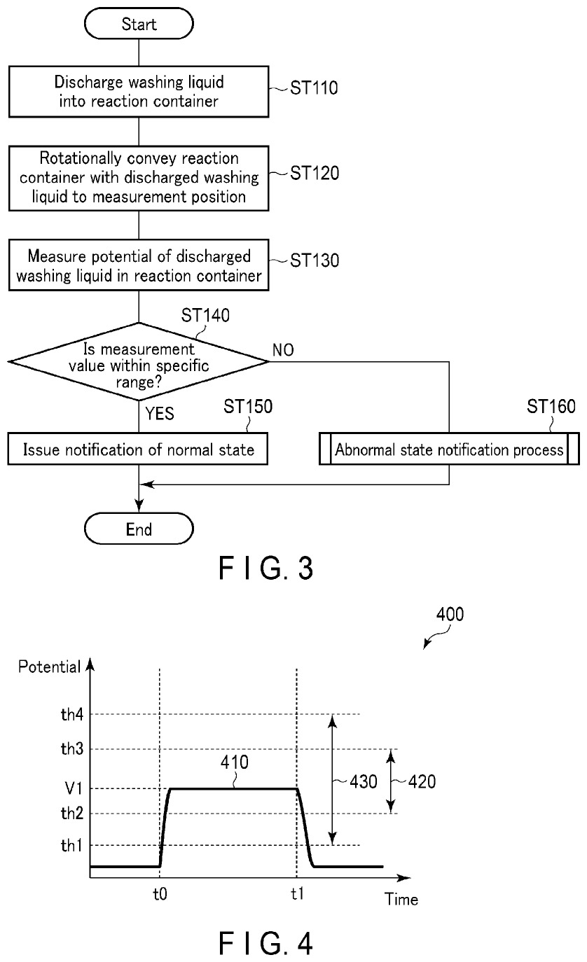

An exemplary configuration of the control circuitry 9 in the automatic analyzing apparatus 1 according to the first embodiment has been described. Next, operations of the automatic analyzing apparatus 1 according to the first embodiment will be described with reference to the flowchart in FIG. 3.

FIG. 3 is a flowchart showing exemplary processing steps in a washing liquid state checking process performed by the automatic analyzing apparatus 1 according to the first embodiment. The washing liquid state checking process is a process for checking the state of a washing liquid used for washing the reaction containers 2011. In one example, the state of a washing liquid relates to a detergent concentration, i.e., the concentration of a detergent contained in the washing liquid.

The washing liquid state checking process shown in FIG. 3 is started at any desired timing while the cycle motion of the automatic analyzing apparatus 1 is not ongoing. Such a desired timing may be, for example, a timing before the start of measurement, a timing after the completion of measurement, a timing after the elapse of a predetermined time during an idle period, and a timing during a maintenance mode. The washing liquid state checking process may be started in response to a user instruction via the input interface 5.

### (Step ST110)

Upon start of the washing liquid state checking process, the control circuitry 9, by using the drive mechanism 4, causes the washing unit 216 to operate. The washing unit 216 thus discharges a washing liquid into an empty reaction container 2011.

### (Step ST120)

After discharge of the washing liquid into the empty reaction container 2011, the control circuitry 9, by using the drive mechanism 4, causes the reaction disk 201 to rotate. The reaction disk 201 thus rotationally conveys the reaction container 2011 containing the discharged washing liquid to a measurement position. The measurement position here may coincide with, for example, the sample discharging position.

### (Step ST130)

After rotational conveyance of the reaction container 2011, the control circuitry 9 carries out the measurement function 92. After carrying out the measurement function 92, the control circuitry 9, by using the drive mechanism 4, causes the sample dispensing probe 207 to be pivoted to the measurement position. After pivoting of the sample dispensing probe 207 to the measurement position, the control circuitry 9 causes the sample dispensing probe 207 to contact the washing liquid within the reaction container 2011. The liquid level detection circuitry 21 connected to the sample dispensing probe 207 measures the electrical potential of the washing liquid and outputs the measurement value to the control circuitry 9.

### (Step ST140)

After electrical potential measurement of the washing liquid, the control circuitry 9 carries out the determination function 93. With the determination function 93, the control circuitry 9 determines whether or not the measurement value is within a specific range. The specific range here is, for example, a range which enables the determination as to whether or not the measurement value represents a normal state. A more detailed description of the specific range in the context of the first embodiment will be given later. Upon determining that the measurement value is within the specific range, a determination result indicative of the measurement value being within the specific range is output, and the process proceeds to step ST150 in the flowchart. If it is determined that the measurement value is not within the specific range, the process proceeds to step ST160.

FIG. 4 is a graph showing an exemplary form of the electrical potential appearing in the liquid level detection for the washing liquid in the first embodiment. FIG. 4 sets forth a graph 400 showing a time-series measurement value 410 with the horizontal axis representing time and the vertical axis representing an electrical potential. It will be assumed that there is a correlation between an electrical potential value and a detergent concentration and, as one example, a greater electrical potential value corresponds to a higher detergent concentration.

The measurement value 410 shows an electrical potential increase at time t0, maintains an electrical potential V1 from approximately time t0 to time t1, and shows an electrical potential drop at time t1. Here, the electrical potential increase is indicative of a contact with the liquid surface, the maintenance of the electrical potential V1 is indicative of a continuous contact with the liquid, and the electrical potential drop is indicative of separation from the liquid surface. In the description below, each measurement value refers to an electrical potential value acquired during the contact with the liquid. Also, the electrical potential V1 corresponds to a predetermined detergent concentration.

The graph 400 also shows multiple thresholds for an electrical potential, namely, a first threshold th1, a second threshold th2, a third threshold th3, and a fourth threshold th4. The multiple thresholds are set such that the electrical potential value increases in the order from the first threshold th1 to the fourth threshold th4. Note that these thresholds are set according to the type of the detergent contained in the washing liquid, and in one example, types of detergents are each associated with a corresponding set of multiple thresholds and stored in the storage circuitry 8.

As the first threshold th1, a value significantly below the electrical potential corresponding to the predetermined detergent concentration is set. If the measurement value is smaller than the first threshold th1, it is suspected, for example, that only a very small amount of the detergent is present or that the detergent is absent, which means that the washing unit 216 may be in a state involving a severe abnormality (a “first abnormal state”), in other words, may be broken.

As the second threshold th2, a value below the electrical potential corresponding to the predetermined detergent concentration is set. If the measurement value is equal to or greater than the first threshold th1 and smaller than the second threshold th2, it is suspected, for example, that the detergent is present in an amount smaller than the predetermined amount, which means that the washing unit 216 may be in a state involving a mild abnormality (a “second abnormal state”), in other words, may require a maintenance work.

As the third threshold th3, a value above the electrical potential corresponding to the predetermined detergent concentration is set. If the measurement value is equal to or greater than the second threshold th2 and smaller than the third threshold th3, it may be recognized, for example, that the amount of the detergent present is in an acceptable range, which means that the washing unit 216 is assumed to be in a normal state.

As the fourth threshold th4, a value significantly above the electrical potential corresponding to the predetermined detergent concentration is set. If the measurement value is equal to or greater than the third threshold th3 and smaller than the fourth threshold th4, it is suspected, for example, that the detergent is present in an amount greater than the predetermined amount, which means that the washing unit 216 may be in a state involving a mild abnormality (a “third abnormal state”), in other words, may require a maintenance work. Also, if the measurement value is equal to or greater than the fourth threshold th4, it is suspected, for example, that a large amount of the detergent has been discharged, which means that the washing unit 216 may be in a state involving a severe abnormality (a “fourth abnormal state”), in other words, may be broken.

The graph 400 further shows a first range 420 and a second range 430. The first range 420 is a range from the second threshold th2 to the third threshold th3. The second range 430 is a range from the first threshold th1 to the fourth threshold th4. The specific range in the context of this embodiment may equal the first range 420. The specific range may also be set to the second range 430 so as to enable determination of a failure or a non-failure.

### (Step ST150)

If it is determined that the measurement value is within the specific range, the control circuitry 9 carries out the notification function 94. With the notification function 94, the control circuitry 9 notifies the user of the normal state. The normal state refers to, for example, a state where the detergent concentration is a proper value (a prescribed value). Upon step ST150, the washing liquid state checking process is terminated.

### (Step ST160)

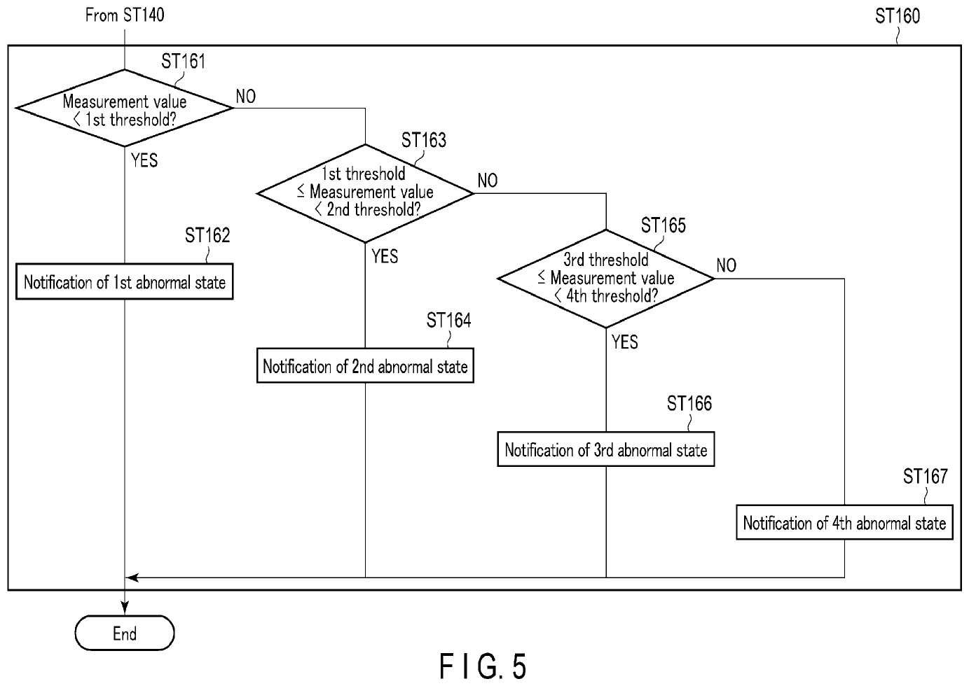

If it is determined that the measurement value is not within the specific range, the control circuitry 9 carries out an abnormal state notification process. The abnormal state notification process is a process to conduct user notification using multiple abnormal state categories. More specifically, in the abnormal state notification process, the measurement value is further compared to one or more thresholds and thereby a notification of one of multiple abnormal states is given. A concrete example of the abnormal state notification process will be described with reference to FIG. 5.

FIG. 5 is a flowchart showing exemplary processing steps in the abnormal state notification process included in the flowchart in FIG. 3. The flowchart in FIG. 5 assumes the use of the above described multiple thresholds.

### (Step ST161)

Upon start of the abnormal state notification process, the control circuitry 9 with the determination function 93 determines whether or not the measurement value is smaller than the first threshold. If it is determined that the measurement value is smaller than the first threshold, the process proceeds to step ST162. If it is determined that the measurement value is not smaller than the first threshold, the process proceeds to step ST163.

### (Step ST162)

Upon determining that the measurement value is smaller than the first threshold, the control circuitry 9 with the notification function 94 issues a notification of the first abnormal state. The first abnormal state refers to, for example, a state where the detergent concentration is significantly lower than the prescribed value. Upon step ST162, the washing liquid state checking process is terminated. Here, the control circuitry 9 may further issue a notification on a condition of the washing liquid preparing mechanism that corresponds to the first abnormal state. In this case, the washing liquid preparing mechanism is deemed to be broken.

### (Step ST163)

Upon determining that the measurement value is not smaller than the first threshold, the control circuitry 9 with the determination function 93 determines whether or not the measurement value is equal to or greater than the first threshold and smaller than the second threshold. If it is determined that the measurement value is equal to or greater than the first threshold and smaller than the second threshold, the process proceeds to step ST164. If it is determined that the measurement value is not equal to or greater than the first threshold and also not smaller than the second threshold, the process proceeds to step ST165.

### (Step ST164)

Upon determining that the measurement value is equal to or greater than the first threshold and smaller than the second threshold, the control circuitry 9 with the notification function 94 issues a notification of the second abnormal state. The second abnormal state refers to, for example, a state where the detergent concentration is lower than the prescribed value. Upon step ST164, the washing liquid state checking process is terminated. Here, the control circuitry 9 may further issue a notification on a condition of the washing liquid preparing mechanism that corresponds to the second abnormal state. In this case, the washing liquid preparing mechanism is deemed to require maintenance work.

### (Step ST165)

Upon determining that the measurement value is not equal to or greater than the first threshold and also not smaller than the second threshold, the control circuitry 9 with the determination function 93 determines whether or not the measurement value is equal to or greater than the third threshold and smaller than the fourth threshold. If it is determined that the measurement value is equal to or greater than the third threshold and smaller than the fourth threshold, the process proceeds to step ST166. If it is determined that the measurement value is not equal to or greater than the third threshold and also not smaller than the fourth threshold, the process proceeds to step ST167.

### (Step ST166)

Upon determining that the measurement value is equal to or greater than the third threshold and smaller than the fourth threshold, the control circuitry 9 with the notification function 94 issues a notification of the third abnormal state. The third abnormal state refers to, for example, a state where the detergent concentration is higher than the prescribed value. Upon step ST166, the washing liquid state checking process is terminated. Here, the control circuitry 9 may further issue a notification on a condition of the washing liquid preparing mechanism that corresponds to the third abnormal state. In this case, the washing liquid preparing mechanism is deemed to require maintenance work.

### (Step ST167)

Upon determining that the measurement value is not equal to or greater than the third threshold and also not smaller than the fourth threshold, the control circuitry 9 with the notification function 94 issues a notification of the fourth abnormal state. The fourth abnormal state refers to, for example, a state where the detergent concentration is significantly higher than the prescribed value. Upon step ST167, the washing liquid state checking process is terminated. Here, the control circuitry 9 may further issue a notification on a condition of the washing liquid preparing mechanism that corresponds to the fourth abnormal state. In this case, the washing liquid preparing mechanism is deemed to be broken.

Note that the control circuitry 9 may, together with conducting the processing in each of the steps ST162, ST164, ST166, and ST167, associate information about the test procedure and each abnormal state with each other. More specifically, and for example, the control circuitry 9 associates each abnormal state with the result of a test for a mixture liquid of a sample and a reagent, conducted prior to the measurement of an electrical potential of the washing liquid. Also, the control circuitry 9 may, together with the processing in each step above, suspend a test to be conducted for a mixture liquid of a sample and a reagent after the measurement of an electrical potential of the washing liquid.

As described above, the automatic analyzing apparatus according to the first embodiment measures an electrical potential pertaining to a contact between a probe for dispensing a reagent or a sample and a liquid surface, outputs the measured electrical potential as a measurement value, determines whether or not the measurement value is within a specific range, outputs the determination result, and issues a notification of a state of the liquid related to the liquid surface according to the determination result. Also, the automatic analyzing apparatus according to the first embodiment issues a notification on the condition of a washing liquid used for washing reaction containers. Therefore, the automatic analyzing apparatus according to the first embodiment, adapted to measure the electrical potential of a washing liquid using a dispensing probe, can detect the state of the washing liquid by means of the simple configuration.

The automatic analyzing apparatus according to the first embodiment, adapted to automatically check the state of a washing liquid during an idle period or the like, can also detect an abnormality in a mechanism for preparing the washing liquid, a mechanism for supplying the washing liquid, etc., before falling into a serious situation. Moreover, in instances where the combination of a given washing liquid and a set of multiple thresholds for electrical potential comparison has been properly established, the automatic analyzing apparatus according to the first embodiment can even detect an erroneous refill of a wrong detergent in the detergent bottle, inclusion of a non-genuine detergent, and so on. Consequently, the automatic analyzing apparatus according to the first embodiment can prevent measurement accuracy deterioration.

### Second Embodiment

The first embodiment has assumed measurement of an electrical potential of the washing liquid to detect the state of the washing liquid. In the second embodiment, an electrical potential of the constant temperature water is measured to detect the state of the constant temperature water. An automatic analyzing apparatus according to the second embodiment may be substantially the same as the automatic analyzing apparatus 1 according to the first embodiment, and therefore, the description of its configuration will be omitted. For the second embodiment, the description will use the same reference signs as those used for the automatic analyzing apparatus 1. The description will basically concentrate on the matters unique to the second embodiment.

According to the second embodiment, the measurement of an electrical potential of the constant temperature water uses at least one of the sample dispensing probe 207, the first reagent dispensing probe 209, and/or the second reagent dispensing probe 211. The description will assume the use of the first reagent dispensing probe 209 for measuring an electrical potential of the constant temperature water.

The first reagent dispensing probe 209 is electrically connected to liquid level detection circuitry. This liquid level detection circuitry may be the same as that employed in the first embodiment, and therefore, its description will be omitted. In one example, the first reagent dispensing probe 209 is also connected to an additive bottle (not illustrated) adapted to retain an additive supplied by an additive supply pump (not illustrated) for supplying the additive, and discharges the additive.

The control circuitry 9 with the measurement function 92 measures an electrical potential pertaining to a contact between the first reagent dispensing probe 209 and a constant temperature water stored in the constant temperature bath 202 and outputs the measured electrical potential as a measurement value.

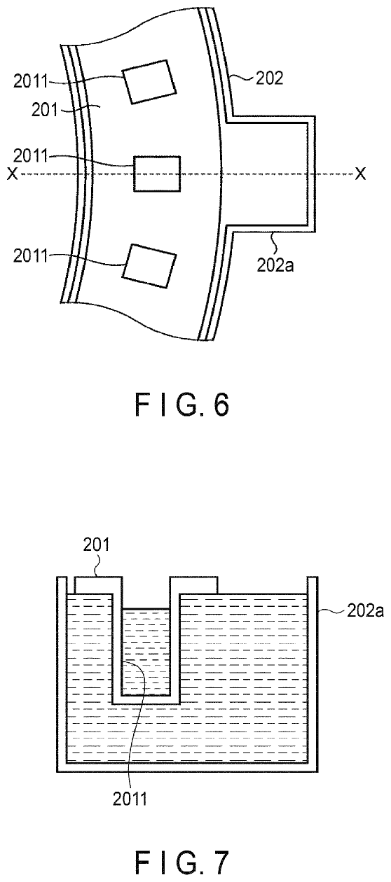

FIG. 6 is a top view of a protrusion 202a of the constant temperature bath 202 shown in FIG. 2. In one example, the protrusion 202a has a shape which, on the straight line extending from the center of the constant temperature bath 202 through the first reagent discharging position, projects toward the constant temperature bath 202 side (projects outwardly). A position between the reaction disk 201 and the protrusion 202a permits an access to the constant temperature water from outside, and therefore, the position may be called a “constant temperature water accessing position”. The constant temperature water accessing position is set on the circling trajectory of the first reagent dispensing probe 209.

FIG. 7 is a sectional view taken along the line X-X indicated in FIG. 6. The first reagent discharging position is set directly above the reaction container 2011, and the constant temperature water accessing position is set directly above the position between the reaction disk 201 and the protrusion 202a.

Note that, for a configuration where the sample dispensing probe 207 is used to measure the electrical potential of the constant temperature water, the protrusion 202a may have a shape which, on the straight line extending from the center of the constant temperature bath 202 through the sample discharging position, projects toward the constant temperature bath 202 side (projects outwardly). Also, for a configuration where the second reagent dispensing probe 211 is used to measure the electrical potential of the constant temperature water, the protrusion 202a may have a shape which, on the straight line extending from the center of the constant temperature bath 202 through the second reagent discharging position, projects toward the constant temperature bath 202 side (projects outwardly).

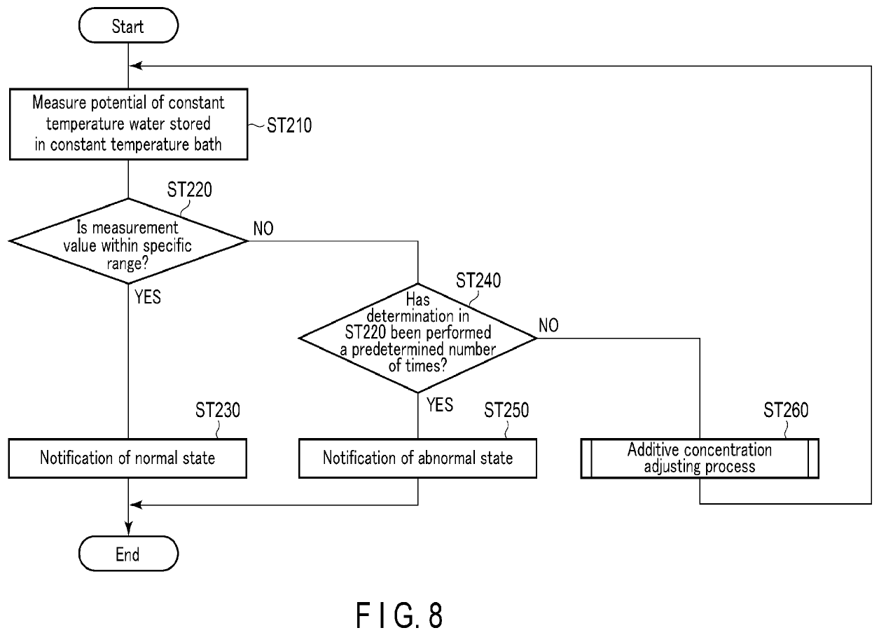

An exemplary configuration of the automatic analyzing apparatus 1 according to the second embodiment has been described. Next, operations of the automatic analyzing apparatus 1 according to the second embodiment will be described with reference to the flowchart in FIG. 8.

FIG. 8 is a flowchart showing exemplary processing steps in a constant temperature water state checking process performed by the automatic analyzing apparatus 1 according to the second embodiment. The constant temperature water state checking process is a process for checking the state of a constant temperature water stored in the constant temperature bath 202. In one example, the state of a constant temperature water relates to an additive concentration, i.e., the concentration of an additive contained in the constant temperature water.

The constant temperature water state checking process shown in FIG. 8 is started at any desired timing while the cycle motion of the automatic analyzing apparatus 1 is not ongoing. Such a desired timing may be set to, for example, a timing before the start of measurement, a timing after the completion of measurement, a timing after elapse of a predetermined time during an idle period, and a timing during a maintenance mode. The constant temperature water state checking process may be started in response to a user instruction via the input interface 5.

### (Step ST210)

Upon start of the constant temperature water state checking process, the control circuitry 9 carries out the measurement function 92. After carrying out the measurement function 92, the control circuitry 9, by using the drive mechanism 4, causes the first reagent dispensing probe 209 to be pivoted to a measurement position. The measurement position here may coincide with, for example, the constant temperature water accessing position. After pivoting of the first reagent dispensing probe 209 to the measurement position, the control circuitry 9 causes the first reagent dispensing probe 209 to contact the constant temperature water within the constant temperature bath 202. The liquid level detection circuitry 21 connected to the first reagent dispensing probe 209 measures the electrical potential of the constant temperature water and outputs the measurement value to the control circuitry 9.

### (Step ST220)

After electrical potential measurement of the constant temperature water, the control circuitry 9 carries out the determination function 93. With the determination function 93, the control circuitry 9 determines whether or not the measurement value is within a specific range. A more detailed description of the specific range in the context of the second embodiment will be given later. Upon determining that the measurement value is within the specific range, a determination result indicative of the measurement value being within the specific range is output, and the process proceeds to step ST230 in the flowchart. If it is determined that the measurement value is not within the specific range, the process proceeds to step ST240.

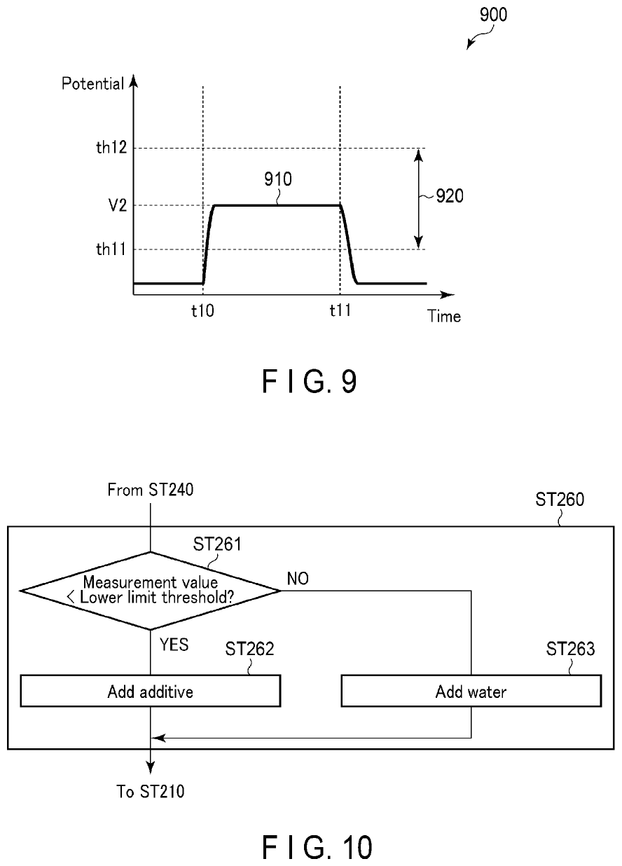

FIG. 9 is a graph showing an exemplary form of the electrical potential which appears in the liquid level detection for the constant temperature water in the second embodiment. FIG. 9 sets forth a graph 900 showing a time-series measurement value 910 with the horizontal axis representing time and the vertical axis representing an electrical potential. It will be assumed that there is a correlation between an electrical potential value and an additive concentration and, as one example, a greater electrical potential value corresponds to a higher additive concentration.

The measurement value 910 shows an electrical potential increase at time t10, maintains an electrical potential V2 from approximately time t10 to time t1l, and shows an electrical potential drop at time t1l. Here, the electrical potential increase is indicative of a contact with the liquid surface, the maintenance of the electrical potential V2 is indicative of a continuous contact with the liquid, and the electrical potential drop is indicative of separation from the liquid surface. In the description below, each measurement value refers to an electrical potential value acquired during the contact with the liquid. Also, the electrical potential V2 corresponds to a predetermined additive concentration.

The graph 900 also shows multiple thresholds for an electrical potential, namely, a lower limit threshold th11 and an upper limit threshold th12. Note that these thresholds are set according to the type of the additive contained in the constant temperature water, and in one example, types of additives are each associated with a corresponding set of multiple thresholds and stored in the storage circuitry 8.

As the lower limit threshold th11, a value below the electric potential corresponding to a predetermined additive concentration is set. If the measurement value is smaller than the lower limit threshold th11, it is suspected, for example, that the additive is present in an amount smaller than the predetermined amount, which means that the additive supply pump may be in a state involving an abnormality, in other words, may require maintenance work or may be broken.

As the upper limit threshold th12, a value above the electric potential corresponding to the predetermined detergent concentration is set. If the measurement value is equal to or greater than the lower limit threshold th11 and smaller than the upper limit threshold th12, it may be recognized, for example, that the amount of the additive present is in an acceptable range, which means that the additive supply pump is assumed to be in a normal state. If the measurement value is equal to or greater than the upper limit threshold th12, it is suspected, for example, that the additive is present in an amount greater than the predetermined amount, which means that the additive supply pump may be in a state involving an abnormality, in other words, may require maintenance work or may be broken.

The graph 900 further shows a specific range 920. The specific range 920 is a range from the lower limit threshold th11 to the upper limit threshold th12. The specific range in the context of this embodiment may equal the specific range 920.

### (Step ST230)

If it is determined that the measurement value is within the specific range, the control circuitry 9 carries out the notification function 94. With the notification function 94, the control circuitry 9 notifies the user of the normal state. Upon step ST230, the constant temperature water state checking process is terminated.

### (Step ST240)

If it is determined that the measurement value is not within the specific range, the control circuitry 9 with the determination function 93 determines whether or not the processing in step ST220 has been performed a predetermined number of times. If it is determined that the number of times of performing the processing in step ST220 has reached the predetermined number, the process proceeds to step ST250. If it is determined that the number of times of performing the processing in step ST220 has not yet reached the predetermined number, the process proceeds to step ST260.

### (Step ST250)

Upon determining YES in step ST240, that is, determining that the measurement has been performed the predetermined number of times, the control circuitry 9 with the notification function 94 issues a notification of the abnormal state to the user. Upon step ST250, the constant temperature water state checking process is terminated. Here, the control circuitry 9 may further issue a notification on a condition of the additive supply pump that corresponds to the abnormal state. In this case, the additive supply pump is deemed to require maintenance work or be broken.

### (Step ST260)

If it is determined that the measurement has not yet been performed the predetermined number of times, the control circuitry 9 conducts an additive concentration adjusting process. The additive concentration adjusting process is a process to adjust the additive concentration that deviates from a prescribed value or values. A concrete example of the additive concentration adjusting process will be described with reference to FIG. 10.

FIG. 10 is a flowchart showing exemplary processing steps in the additive concentration adjusting process included in the flowchart in FIG. 8. The flowchart in FIG. 10 assumes the use of the lower limit threshold of the multiple thresholds described above.

### (Step ST261)

Upon start of the additive concentration adjusting process, the control circuitry 9 with the determination function 93 determines whether or not the measurement value is smaller than the lower limit threshold. If it is determined that the measurement value is smaller than the lower limit threshold, the process proceeds to step ST262. If it is determined that the measurement value is not smaller than the lower limit threshold, the process proceeds to step ST263.

### (Step ST262)

Upon determining that the measurement value is smaller than the lower limit threshold, the control circuitry 9 conducts addition of the additive to the constant temperature water. More specifically, the control circuitry 9, by using the drive mechanism 4, causes the additive supply pump to operate so that the additive is discharged from the first reagent dispensing probe 209 to the constant temperature water. The amount of the additive to be discharged may be set to, for example, a constant amount or a variable amount according to measurement values. After step ST262, the process returns to step ST210.

### (Step ST263)

Upon determining that the measurement value is not smaller than the lower limit threshold, the control circuitry 9 conducts addition of water to the constant temperature water. More specifically, the control circuitry 9, by using the drive mechanism 4, causes a water supply pump to suction water from a water tank (not illustrated) connected to the first reagent dispensing probe 209 so that water is discharged to the constant temperature water. The amount of the water to be discharged may be set to, for example, a constant amount or a variable amount according to measurement values. After step ST263, the process returns to step ST210.

As described above, the automatic analyzing apparatus according to the second embodiment measures an electric potential pertaining to a contact between a probe for dispensing a reagent or a sample and a liquid surface, outputs the measured electrical potential as a measurement value, determines whether or not the measurement value is within a specific range, outputs the determination result, and issues a notification of a state of the liquid related to the liquid surface according to the determination result. Also, the automatic analyzing apparatus according to the second embodiment issues a notification on the condition of a constant temperature water present in a constant temperature bath for warming and maintaining a liquid contained in each reaction container at a constant temperature. Therefore, the automatic analyzing apparatus according to the second embodiment, adapted to measure the electrical potential of a constant temperature water using a probe, can detect the state of the constant temperature water by means of the simple configuration. The automatic analyzing apparatus according to the second embodiment, adapted to automatically check the state of a constant temperature water during an idle period or the like, can also detect an abnormality in mechanisms such as a mechanism for supplying an additive, before falling into a serious situation.

According to at least one embodiment in the foregoing description, the state of a liquid can be detected by a simple configuration.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

What is claimed is:

1. An automatic analyzing apparatus comprising processing circuitry configured to:
measure an electrical potential pertaining to a contact between a probe for dispensing a sample or a reagent and a liquid surface, and output the measured electrical potential as a measurement value;
determine whether or not the measurement value is within a specific range, and output a determination result; and
provide a notification on a state of a liquid related to the liquid surface according to the determination result.

2. The automatic analyzing apparatus according to claim 1, wherein the processing circuitry is further configured to provide a notification of a normal state as the state of the liquid if the measurement value is within the specific range, and provide a notification of an abnormal state as the state of the liquid if the measurement value is not within the specific range.

3. The automatic analyzing apparatus according to claim 1, wherein the processing circuitry is further configured to associate the state of the liquid with a result of a test for a mixture liquid of the sample and the reagent conducted prior to the measuring.

4. The automatic analyzing apparatus according to claim 1, wherein the processing circuitry is further configured to suspend, if the measurement value is not within the specific range, a test for a mixture liquid of the sample and the reagent conducted after the measuring.

5. The automatic analyzing apparatus according to claim 2, wherein the processing circuitry is further configured to
compare, if the measurement value is not within the specific range, the measurement value to one or more thresholds to output the determination result, and
provide a notification of one of a plurality of abnormal states according to the determination result.

6. The automatic analyzing apparatus according to claim 1, wherein the liquid is a washing liquid for washing a reaction container.

7. The automatic analyzing apparatus according to claim 6, wherein the state of the liquid relates to a concentration of a detergent contained in the washing liquid.

8. The automatic analyzing apparatus according to claim 6, wherein the processing circuitry is further configured to provide a notification on a state of a mechanism for preparing the washing liquid, according to the determination result.

9. The automatic analyzing apparatus according to claim 2, wherein the processing circuitry is further configured to
determine, if the measurement value is not within the specific range, whether or not a number of times of the determining has reached a predetermined number, and
provide the notification of the abnormal state if the number of times of the determining has reached the predetermined number.

10. The automatic analyzing apparatus according to claim 1, wherein the liquid is a constant temperature water in a constant temperature bath for warming and maintaining a liquid in a reaction container at a constant temperature.

11. The automatic analyzing apparatus according to claim 10, wherein the state of the liquid relates to a concentration of an additive contained in the constant temperature water.

12. The automatic analyzing apparatus according to claim 11, wherein the processing circuitry is further configured to provide a notification on a state of a pump for supplying the additive, according to the determination result.

13. The automatic analyzing apparatus according to claim 11, wherein the processing circuitry is further configured to
determine, if the measurement value is not within the specific range, whether or not a number of times of the determining has reached a predetermined number, and
compare, if the number of times of the determining has not reached the predetermined number, the measurement value to a predetermined threshold to adjust the concentration of the additive.

14. The automatic analyzing apparatus according to claim 1, further comprising
the probe, and
a liquid level detector electrically connected to the probe and configured to detect the contact between the probe and the liquid surface.

15. The automatic analyzing apparatus according to claim 2, wherein the liquid is a washing liquid for washing a reaction container.

16. The automatic analyzing apparatus according to claim 2, wherein the liquid is a constant temperature water in a constant temperature bath for warming and maintaining a liquid in a reaction container at a constant temperature.

17. The automatic analyzing apparatus according to claim 9, wherein the liquid is a constant temperature water in a constant temperature bath for warming and maintaining a liquid in a reaction container at a constant temperature.

18. The automatic analyzing apparatus according to claim 2, further comprising
the probe, and
a liquid level detector electrically connected to the probe and configured to detect the contact between the probe and the liquid surface.

19. The automatic analyzing apparatus according to claim 9, further comprising
the probe, and
a liquid level detector electrically connected to the probe and configured to detect the contact between the probe and the liquid surface.

20. An automatic analyzing method comprising:
measuring an electrical potential pertaining to a contact between a probe for dispensing a sample or a reagent and a liquid surface, and outputting the measured electrical potential as a measurement value;
determining whether or not the measurement value is within a specific range, and outputting a determination result; and
providing a notification on a state of a liquid related to the liquid surface according to the determination result.
